(19) United States
(12) Patent Application Publication
(10) Pub. No.: US 2026/0148230 A1
(43) Pub. Date: May 28, 2026

(54) CONFIGURABLE TRANSACTION FREEZE

(71) Applicant: Bank of America Corporation, Charlotte, NC (US)

(72) Inventors: Patricia Anne Gillis, Chicago, IL (US); Nisha Sen, New York, NY (US)

(21) Appl. No.: 18/960,060

(22) Filed: Nov. 26, 2024

(51) Int. Cl. G06Q 20/40; G06N 20/00

(52) U.S. Cl. CPC G06Q 20/401; G06N 20/00

(57) ABSTRACT

Apparatus, methods and systems for generating and executing configurable guardrails to select and freeze attempted transactions. Methods may include receiving, from a user, a plurality of thresholds that are used to determine whether to enable an attempted transaction to be executed. Methods may include dynamically updating the plurality of thresholds using an AI model. Methods may include classifying, into a plurality of transaction groups, transactions that are attempted from a plurality of payment accounts. Methods may include using the updated plurality of thresholds to determine transaction execution instructions for each transaction group. Methods may include comparing the transaction execution instructions for each transaction group to previously executed transaction execution instructions. Methods may include generating guardrails, using a feedback loop, to enable automatic execution of transaction execution instructions without input from the user.

### FIELD OF TECHNOLOGY

Aspects of the disclosure relate to artificial intelligence.

### BACKGROUND OF THE DISCLOSURE

Entities may operate payment accounts at financial institutions. Entities may control each of the various different payment accounts. Each payment account involves numerous different transactions. Typical payment account control, enabled by the financial institution, allows the entity to control each payment account individually or to control all of the payment accounts as one unit. Current payment account control options do not enable the entity to manipulate a group of transactions, such as transactions originating from more than one payment account.

Additionally, current payment account control options include logic-based control. Logic-based control does not enable the entity to dynamically update/adapt control options based on changes within the entity or external to the entity. Rather, current logic-based control requires physical reprogramming. Furthermore, the logic-based control is not based on real-time information. Therefore, once a logic-based control option is changed, the logic-based control option executes unnecessary control on different payment accounts, because the logic parameters may be expired and/or no longer relevant.

It may therefore be desirable to provide a system to monitor and control attempted transactions originating from a plurality of payment accounts. It may be further desirable to provide a real-time, self-learning system that monitors and controls the attempted transactions. Such a system may adapt to changes and update its control parameters accordingly.

### SUMMARY OF THE DISCLOSURE

Systems, apparatus and methods for generating and executing configurable guardrails to select and freeze attempted transactions are provided.

The methods may leverage artificial intelligence (“AI”).

The methods may include receiving a plurality of parameters. The plurality of parameters may be received from a user. The user may be associated with an entity. The entity may operate a plurality of payment accounts. Each of the plurality of payment accounts may be configured to execute transactions. Each of the plurality of payment accounts may be configured to transfer resources from the entity to one or more recipient(s). The one or more recipients may include other entities, payment accounts, users and/or any other suitable recipient(s).

The user may control the plurality of payments accounts.

The plurality of parameters may include a transaction amount limitation, a specified geolocation, a time constraint and/or any other suitable parameters.

Each of the plurality of parameters may be associated with a threshold. Each threshold may be defined by the user. Each threshold may be termed a standard threshold. Each threshold may be used to determine whether to execute an attempted transaction. For example, a threshold may include a maximum transaction amount. A transaction that attempts to transfer a number of resources greater than the maximum transaction amount may be halted. A transaction that attempts to transfer a number of resources less than or equal to the maximum transaction amount may be executed.

The methods may include dynamically updating the plurality of parameters. An AI model may be used to update the plurality of parameters. The AI model may execute on a computing device. The computing device may include a processor. The computing device may include a desktop computer, laptop, tablet, smartphone, mainframe computer and any other suitable computing devices. The computing device may be operated by the entity, a financial institution that operates the account or any other suitable source.

The AI model may include progressive learning algorithms. The progressive learning algorithms may ingest training data. The progressive learning algorithms may analyze the ingested training data. The progressive learning algorithms may analyze the training data for correlations and patterns within the data. The progressive learning algorithms may use the analyzed correlations and patterns to generate outputs. The AI model may update the progressive learning algorithms based on the generated outputs curated/retrieved from the analyzed correlations and patterns.

The AI model may include machine learning algorithms. Machine learning algorithms may enable the AI model to learn from experience without specific instructional programming. The AI model may include deep learning algorithms. Deep learning algorithms may utilize neural networks. Neural networks may use interconnected nodes or neurons in a layered structure to analyze data and generate outputs.

The AI model may receive real-time transactional data. The AI model may receive real-time transactional data via a live data feed. The real-time transactional data may include publicly available transactional data. Publicly available transactional data may include data that can be shared, used, reused and/or redistributed without restriction. Publicly available data may include data that can be accessed via online applications, websites and any other suitable public source. The real-time transactional data may include internal entity transactional data. Internal entity transactional data may include private data. Internal entity transactional data may include data relating to ongoing transactions at the entity.

The AI model may receive historical transactional data. The historical transactional data may include private data. The historical transactional data may include data relating to previously executed transactions at the entity. The historical transactional data may be stored in a memory location. The memory location may be operated by the entity.

The methods may include monitoring the plurality of payment accounts. The AI model may monitor the plurality of payment accounts.

In parallel with the monitoring, the methods may include classifying transactions that are attempted via the plurality of payment accounts. Attempted transactions may include transactions in which an initiator of the transaction requests completion of the transaction. Initiators of the transaction may include swiping a credit card, placing credit card credentials through a webpage, requesting a transfer of resources, a preprogrammed transfer of resources and/or any other suitable transaction initiators.

The transactions may be classified into a plurality of transaction groups. Each transaction group may include transactions that each include at least one shared transaction characteristic. For example, transactions that include resources being transferred to one recipient may be grouped in a first transaction group. Transactions that include resources being transferred within in a specified geolocation may be grouped into a second transaction group. Transactions that include a specific number of resources being transferred may be grouped into a third transaction group. Transactions that include resources being transferred via the same payment method may be grouped into a fourth group. Transaction groups may be formed from any suitable identified shared transaction characteristics. Transaction groups may be included in one or more transaction groups.

The methods may include using the updated plurality of parameters to determine transaction execution instructions for each transaction group. The methods may include using the updated plurality of parameters to determine a transaction execution instruction for each attempted transaction. Transaction execution instructions may include instructions to freeze a transaction/transaction group, to enable a transaction/transaction group, to delay a transaction/transaction group, to flag a transaction/transaction group and/or any other suitable transaction execution instruction.

The methods may include transmitting a plurality of transaction recommendations to the user. Each transaction recommendation may include the determined transaction execution instructions for each transaction group. Each transaction recommendation may include the determined transaction execution instruction for each transaction.

Each transaction may include a recommendation along with the determined transaction execution instruction(s). The recommendation may include a numeric value, an alphanumeric sequence, a percentage and/or any other suitable recommendation metric. The numeric value, the alphanumeric sequence, the percentage and any other suitable recommendation metric may indicate a predicted confidence level of whether the determined transaction execution instruction is the appropriate transaction instruction for each transaction/transaction group.

Once the transaction recommendation is transmitted to the user, the user may decide whether or not to execute the transaction execution instruction included in each transaction recommendation. After every decision, the transaction recommendation and associated decision may be stored at the memory location.

In parallel with transmitting the transaction recommendations, the methods may include comparing the transaction recommendations for each transaction group to historical transaction recommendations that were made for each transaction group. The AI model may compare the transaction recommendations to the historical transaction recommendations. The historical transactions recommendations may be stored at the memory location. Comparing the transaction recommendations to the historical transaction recommendations may further train the AI model.

Based on the comparing, the methods may include updating the transaction execution instructions via the AI model. The methods may include using a feedback loop to generate guardrails. The guardrails may enable automatic execution of transaction recommendations without input from the user.

Generating the guardrails may include assigning an accuracy score to each iteration of the feedback loop. Each iteration of the feedback loop may include a generated transaction recommendation for a transaction group. Each iteration of the feedback loop may include a predicted transaction execution decision based on the historical transactional data. The historical data may be retrieved from the memory location. The predicted transaction decision may be predicted using the AI model. The accuracy score may be a percentage such as 5%, 10% or any other suitable percentage. The accuracy score may be a decimal number such as, 0.1, 0.2, 0.3 or any other suitable decimal number. The accuracy score may be a whole number such as 1, 2 and 3 or any other suitable whole number.

Generating the guardrails may include setting an accuracy score bracket. The accuracy score bracket may reflect a range of accuracy scores that indicate that the transaction recommendation is substantially the same as the predicted transaction execution decision. The accuracy score bracket may be set by the AI model. The accuracy score bracket may be dynamically updated, as the AI model is continuously trained.

For each iteration of the feedback loop, the AI model may determine whether the accuracy score assigned to the iteration is included in the accuracy score bracket. In response to determining that the accuracy score is included in the accuracy score bracket, the methods may include automatically executing the transaction execution instruction included in the transaction recommendation that is associated with the iteration. In response to determining that the accuracy score is not included in the accuracy score bracket, the methods may include transmitting the transaction recommendation to the user. Additionally, in response to determining that the accuracy score is not included in the accuracy score bracket, the transaction execution instruction may be deleted.

When the user receives a transaction recommendation, the user may be provided with selectable options whether to execute the received transaction recommendation. Selection, by the user, of a selectable option to execute the received transaction recommendation may result in an execution of the transaction execution instruction included in the transaction recommendation. In the event that the feedback loop determines that the received transaction recommendation has an accuracy score included in the accuracy score bracket, the received transaction recommendation may not be transmitted to the user. Instead of the received transaction recommendation being transmitted to the user, the received transaction recommendation may be executed automatically without input from the user.

The methods may further include ranking each transaction group based on a transaction importance level. A transaction importance level may be assigned based on a transaction amount. A transaction importance level may be assigned based on a transaction recipient. A transaction importance level may be assigned based on a transaction frequency. A transaction importance level may be assigned based on any suitable factor. For transaction groups assigned a transaction importance level that is determined to be above a threshold transaction importance level, the methods may include initiating an AI model override. The AI model override may disable automatic execution of a transaction recommendation. The AI model override may disable automatic execution of a transaction recommendation even in the event that an assigned accuracy score is included in the accuracy score bracket.

After executing transaction recommendation, the methods may include displaying, on a digital display, an option for the user to reverse the executed transaction recommendation or to enforce the executed transaction recommendation. The option may only be valid during a specific time frame. The specific time frame may be a one or more seconds, one or more minutes, one or more days or any other suitable time frame. Upon completion of the time frame, without selection of one or the available options, the user may be unable to reverse the executed transaction recommendation.

When the transaction recommendation includes a transaction execution instruction to freeze transactions included in a transaction group, reversing the executed transaction recommendation may include unfreezing the transactions. When the transaction recommendation includes a transaction execution instruction to delay transactions included in a transaction group, reversing the executed transaction recommendation may include executing the transactions.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows yet another illustrative diagram in accordance with principles of the disclosure;

FIG. 5 shows an illustrative diagram in accordance with principles of the disclosure; and

FIG. 6 shows yet another illustrative diagram in accordance with principles of the disclosure.

### DETAILED DESCRIPTION OF THE DISCLOSURE

Systems, apparatus and methods for generating and executing configurable guardrails to select and freeze attempted transactions is provided.

The apparatus may include a user account. The user account may be associated with an entity. The user account may operate/execute on a user device. The user device may be a computing device such as a smartphone, laptop, tablet, desktop, mainframe computer and/or any other suitable computing device. The user account may be an entity-related identity/authenticator created for the user.

The user account may control a plurality of payment accounts. The plurality of payment accounts may be operated by the entity. Each payment account may be configured to execute transactions. Each payment account may be configured to transfer resources to at least one recipient.

The apparatus may include an AI model. The AI model may be operated by the entity. The AI model may execute on a computing device. The computing device may include a processor. The computing device may include at least one machine learning engine. The computing device may include a desktop computer, laptop, tablet, smartphone, mainframe computer and any other suitable computing devices.

The AI model may include progressive learning algorithms. The progressive learning algorithms may ingest training data. The progressive learning algorithms may analyze the ingested training data. The progressive learning algorithms may analyze the training data for correlations and patterns within the data. The progressive learning algorithms may use the analyzed correlations and patterns to generate outputs. The AI model may update the progressive learning algorithms based on the generated outputs curated/retrieved from the analyzed correlations and patterns.

The AI model may include machine learning algorithms. Machine learning algorithms may enable the AI model to learn from experience without specific instructional programming. The AI model may include deep learning algorithms. Deep learning algorithms may utilize neural networks. Neural networks may use interconnected nodes or neurons in a layered structure to analyze data and generate outputs.

The AI model may receive a plurality of parameters from a user associated with the user account. Each parameter included in the plurality of parameters may be associated with a threshold. Each threshold may be used to determine whether to enable an attempted transaction to be executed.

The AI model may receive real-time transactional data via a live data feed. The real-time transactional data may include publicly available transactional data. The real-time transactional data may include internal entity transactional data. The AI model may receive historical transactional data. The AI model may dynamically update the plurality of parameters using the real-time transactional data and the historical transaction data.

The AI model may monitor attempted transactions being executed from the plurality of payment accounts. As the AI model monitors the attempted transactions, the AI model may classify the attempted transactions into a plurality of transaction groups. Each transaction group may include transactions that each include at least one shared transaction characteristic. Shared transaction characteristics may include common recipients, similar locations from which the transactions are requested, shared amounts of resources being transferred per transaction, same payment methods and/or any other suitable shared transaction characteristics.

The AI model may use the updated plurality of parameters to determine transaction execution instructions for each transaction group. Transaction execution instructions may include instructions to freeze a transaction/transaction group, to enable a transaction/transaction group, to delay a transaction/transaction group, to flag a transaction/transaction group and/or any other suitable transaction execution instruction.

The AI model may transmit a plurality of transaction recommendations to the user. Each transaction recommendation may include the determined transaction execution instructions for each transaction/transaction group.

In parallel with the transmission, the AI model may compare the transaction recommendations for each transaction group to historical transaction recommendations that were made for each transaction group. The comparison may be further used to train the AI model. The AI model may update the transaction execution instructions based on the comparison. The AI model may transmit the updated transaction execution instructions to the user.

The AI model may use a feedback loop to generate guardrails that may enable automatic execution of transaction recommendations without input from the user. The AI model may assign an accuracy score to each iteration of the feedback loop. Each iteration of the feedback loop may include a generated transaction recommendation. Each iteration of the feedback loop may include a predicted transaction execution decision based on the historical transactional data.

The AI model may set an accuracy score bracket. The accuracy score bracket may reflect a range of accuracy scores that indicate that the transaction recommendation is substantially the same as the predicted transaction execution decision.

For each iteration of the feedback loop, the AI model may determine whether the accuracy score assigned to the iteration is included in the accuracy score bracket. In response to the determination that the accuracy score is included in the accuracy score bracket, the AI model may automatically execute the transaction recommendation associated with the iteration. In response to the determination that the accuracy score is not included in the accuracy score bracket, the AI model may transmit the transaction recommendation to the user.

The user account may include a graphical user interface. The graphical user interface may include a digital user interface. The graphical user interface may include a display. The user may be provided, via the graphical user interface, with selectable options whether to execute a received transaction recommendation. Selection, by the user, to execute the received transaction recommendation may result in an execution of transaction execution instruction included in the transaction recommendation.

In the event that the feedback loop determines that the received transaction recommendation has an accuracy score included in the accuracy score bracket, the received transaction recommendation may not be transmitted the user and, instead, may be executed automatically without input from the user.

The AI model may rank each transaction group based on a transaction importance level. A transaction importance level may be assigned based on a transaction amount. A transaction importance level may be assigned based on a transaction recipient. A transaction importance level may be assigned based on a transaction frequency. A transaction importance level may be assigned based on any suitable factor. For transaction groups assigned a transaction importance level that is determined to be above a threshold transaction importance level, an AI model override may be initiated. The AI model override may disable automatic execution of a transaction recommendation. The AI model override may disable automatic execution of a transaction recommendation even in the event that an assigned accuracy score is included in the accuracy score bracket.

After executing transaction recommendation, an option may be displayed on the graphical user interface. The option may enable the user to reverse the executed transaction recommendation and/or to enforce the executed transaction recommendation. The option may only be valid during a specific time frame. The specific time frame may be one or more seconds, one or more minutes, one or more days and/or any other suitable time frame.

When the transaction recommendation includes a transaction execution instruction to freeze transactions included in a transaction group, reversing the executed transaction recommendation may include unfreezing the transactions. When the transaction recommendation includes a transaction execution instruction to delay transactions included in a transaction group, reversing the executed transaction recommendation may include executing the transactions.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

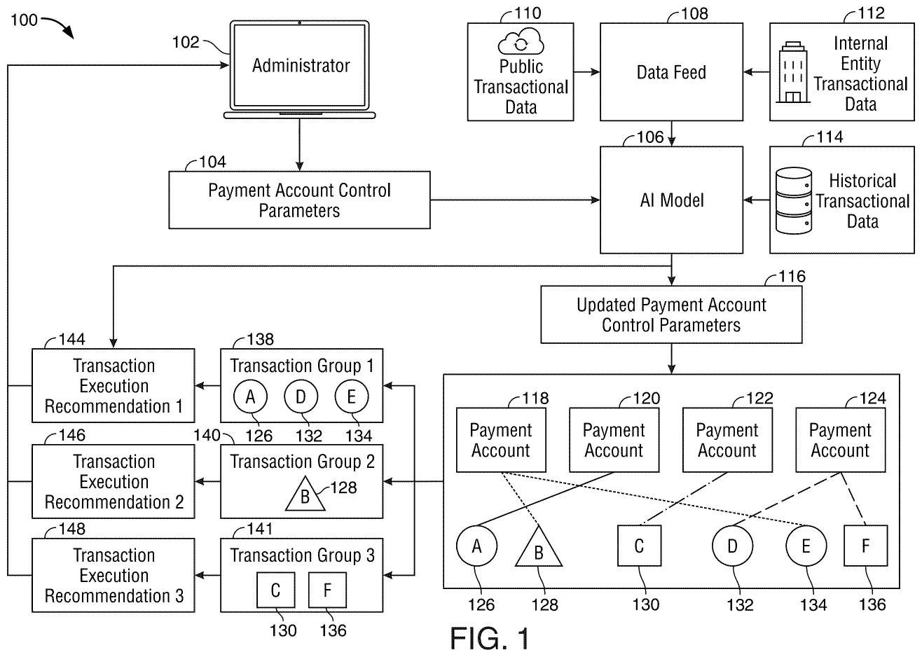

FIG. 1 shows illustrative transaction control system 100. Administrator 102 may be associated with an entity. The entity may operate payment accounts 118, 120, 122 and 124. Administrator 102 may include a computing device. The computing device may include a smartphone, laptop, tablet, desktop computer, mainframe computer and any other suitable computing devices.

Administrator 102 may input payment account control parameters 104. Payment account control parameters 104 may be set of parameters used to control transactions being executed from payment accounts 118, 120, 122 and 124. Examples of payment account control parameters 104 may include a maximum amount of resources that can be transferred in a transaction, geolocations in which transactions cannot be made, recipients that cannot be included in transactions and any other suitable payment account control parameters.

Transaction control system 100 may include AI model 106. AI model 106 may be instantiated on a computing device. The computing device may include a processor. The computing device may be an entity-operated computing device.

AI model 106 may receive data from data feed 108. Data feed 108 may include public transactional data 110 and internal entity transaction data 112. Public transactional data 110 and internal entity transaction data 112 may include real-time data. Public transactional data 110 and internal entity transaction data 112 may be updated, continually, in real-time.

AI model 106 may receive historical transaction data 114. Historical transactional data 114 may include data relating to previously executed transactions. Historical transactional data 114 may be stored in a storage location associated with the entity.

AI model 106 may update payment account control parameters 104 using public transactional data 110, internal entity transaction data 112 and historical transactional data 114. AI model 106 may generate updated payment account control parameters 116. Examples of updated payment account control parameters 116 may include updated maximum amounts of resources that can be transferred in a transaction, updated geolocations in which transactions cannot be made, updated recipients that cannot be included in transactions and any other suitable updated payment account control parameters.

Payment accounts 118, 120, 122 and 124 may be monitored using updated payment account control parameters 116.

Payment account 118 may attempt to execute transaction 128 and transaction 134. Payment account 120 may attempt to execute transaction 126. Payment account 122 may attempt to execute transaction 130. Payment account 124 may attempt to execute transaction 132 and transaction 136.

AI model 106 may group attempted transactions 126, 128, 130, 132, 134 and 136 by identifying similar transaction characteristics within the attempted transactions. Similar transaction characteristics may include a common recipient, a similar location of the transaction, a shared number of resources being transferred, a same payment method of the transaction and/or any suitable identified shared transaction characteristics.

AI model 106 may group attempted transactions 126, 132 and 134 into transaction group 138. AI model 106 may group attempted transaction 128 into transaction group 140. AI model 106 may group attempted transactions 130 and 136 into transaction group 141.

Using updated payment account control parameters 116, AI model 106 may generate transaction execution recommendations for each transaction group. Transaction execution recommendations may include transaction execution instructions. Transaction execution instructions may include instructions to enable the attempted transaction to be executed, to freeze the attempted transaction, to delay the attempted transaction and/or to prevent the attempted transaction from being executed. AI model 106 may generate transaction execution recommendation 144 for transaction group 138. AI model 106 may generate transaction execution recommendation 146 for transaction group 140. AI model 106 may generate transaction execution recommendation 148 for transaction group 141.

Transaction execution recommendations 144, 146 and 148 may be transmitted to administrator 102. Administrator 102 may determine whether to execute the transaction execution recommendations.

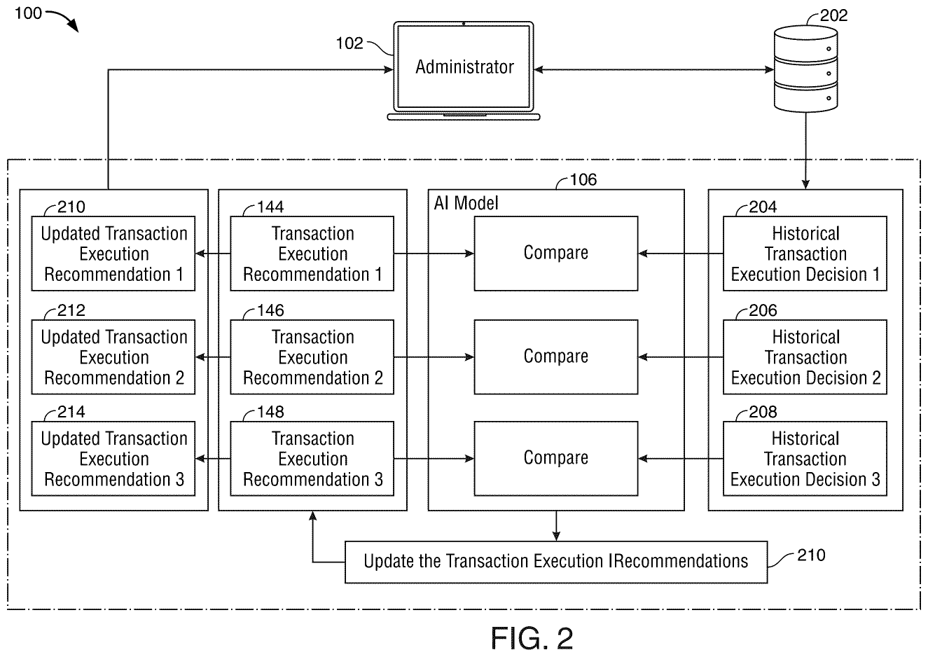

FIG. 2 shows a continuation of illustrative transaction control system 100. In parallel with transmitting transaction execution recommendations 144, 146 and 148 to administrator 102, AI model 106 may compare transaction execution recommendations 144, 146 and 148 to historical transaction execution decisions. Historical transaction execution decisions may be stored in database 202. Database 202 may be associated with the entity.

AI model 106 may identify historical transaction execution decisions that are determined to be within a threshold level of similarity for each transaction execution recommendation. AI model 106 may identify that historical transaction execution decision 204 may be within a threshold level of similarity of transaction execution recommendation 144. AI model 106 may identify that historical transaction execution decision 206 may be within a threshold level of similarity of transaction execution recommendation 146. AI model 106 may identify that historical transaction execution decision 208 may be within a threshold level of similarity of transaction execution recommendation 148.

AI model 106 may compare historical transaction execution decision 204 to transaction execution recommendation 144. AI model 106 may compare historical transaction execution decision 206 to transaction execution recommendation 146. AI model 106 may compare historical transaction execution decision 208 to transaction execution recommendation 148. Based on comparing historical transaction execution decisions 204, 206 and 208 to transaction execution recommendations 144, 146 and 148, respectively, AI model 106 may update transaction execution recommendations 144, 146 and 148.

AI model 106 may update transaction execution recommendation 144 to updated transaction execution recommendation 210. AI model 106 may update transaction execution recommendation 146 to updated transaction execution recommendation 212. AI model 106 may update transaction execution recommendation 148 to updated transaction execution recommendation 214.

Updated transaction execution recommendations 210, 212 and 214 may include updates that were generated in response to identifying discrepancies between historical transaction execution decisions 204, 206 and 208 and transaction execution recommendations 144, 146 and 148.

Updated transaction execution recommendations 210, 212 and 214 may be transmitted to administrator 102. Updated transaction execution recommendations 210, 212 and 214 may overwrite transaction execution recommendations 144, 146 and 148.

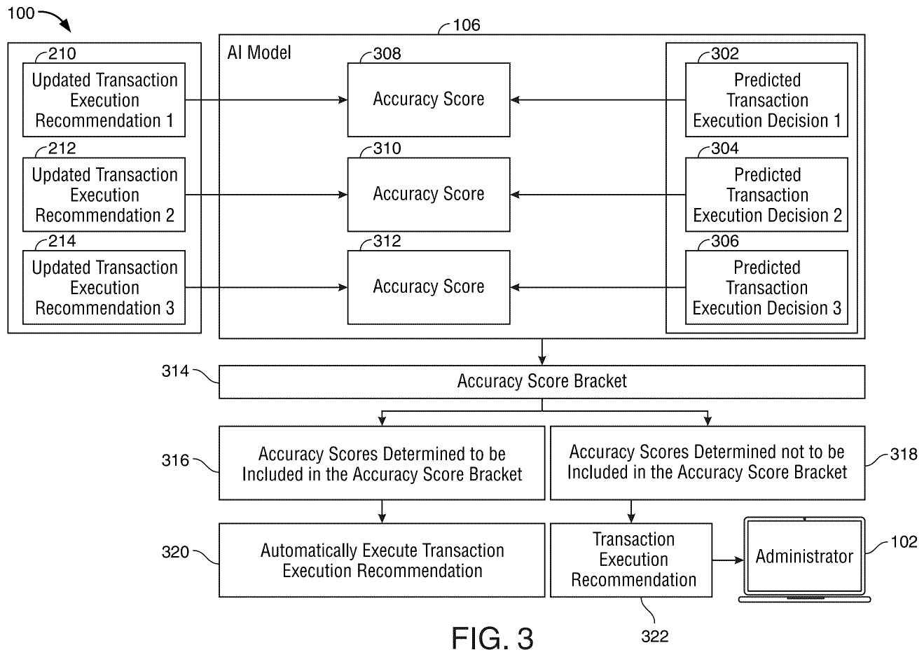

FIG. 3 shows a continuation of illustrative transaction control system 100. After generating updated transaction execution recommendations 210, 212 and 214, AI model 106 may determine an accuracy score for each transaction execution recommendation.

AI model 106 may determine accuracy scores by comparing each of transaction execution recommendations 210, 212 and 214 to corresponding predicted transaction execution decisions. AI model 106 may predict transaction execution decisions using public transactional data 110, internal entity transaction data 112 and historical transactional data 114 (as shown in FIG. 1).

AI model 106 may assign accuracy score 308 to updated transaction execution recommendation 210, based on comparing updated transaction execution recommendation 210 to predicted transaction execution decision 302. The comparison of updated transaction execution recommendation 210 to predicted transaction execution decision 302 may be a first iteration of a feedback loop. AI model 106 may assign accuracy score 310 to updated transaction execution recommendation 212, based on comparing updated transaction execution recommendation 212 to predicted transaction execution decision 304. The comparison of updated transaction execution recommendation 212 to predicted transaction execution decision 304 may be a second iteration of the feedback loop. AI model 106 may assign accuracy score 312 to updated transaction execution recommendation 214, based on comparing updated transaction execution recommendation 214 to predicted transaction execution decision 306. The comparison of updated transaction execution recommendation 214 to predicted transaction execution decision 306 may be a third iteration of the feedback loop.

After assigning accuracy scores 308, 310 and 312, AI model 106 may determine whether accuracy scores 308, 310 and 312 are included in accuracy score bracket 314. Accuracy score bracket 314 may reflect a range of accuracy scores that indicate that a transaction recommendation is substantially the same as a corresponding predicted transaction execution decision.

At step 318, AI model 106 may determine that an accuracy score is not included in accuracy score bracket 314. In response to determining that an accuracy score is not included in accuracy score bracket 314, step 322 may include transmitting the corresponding transaction execution recommendation to administrator 102.

At step 316, AI model 106 may determine that an accuracy score is included in accuracy score bracket 314. In response to determining that an accuracy score is included in accuracy score bracket 314, step 320 may include automatically executing the corresponding transaction execution recommendation without any input from administrator 102.

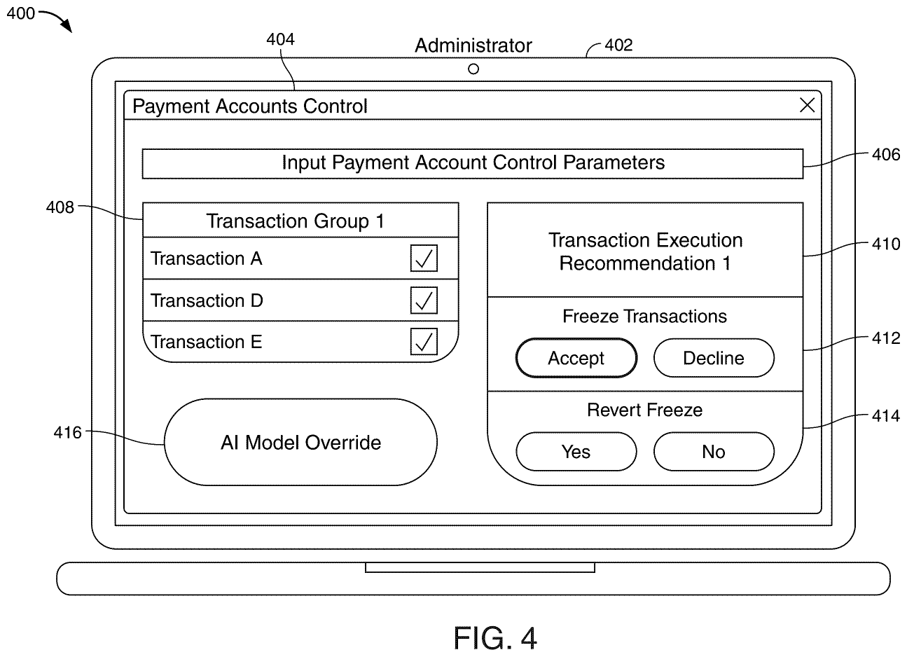

FIG. 4 shows illustrative user interface 400. User interface 400 may include one or more features in common with transaction control system 100.

Administrator 402 may operate payment accounts control system 404. Payment accounts control system 404 may be used to monitor and control a plurality of payment accounts. The plurality of payment accounts may be operated by an entity.

Payment accounts control system 404 may include input prompt 406. Input prompt 406 may be configured to receive payment account control parameters from administrator 402. Payment account control parameters may include a maximum amount of resources that can be transferred in a transaction, locations in which transactions cannot be made, recipients that cannot be included in transactions and any other suitable payment account control parameter.

An AI model may receive the payment account control parameters input by administrator 402. The AI model may sort the attempted transactions made by the payment accounts into transaction groups based on the payment account control parameters. For each transaction group, payment accounts control system 404 may display a transaction grouping, such as grouping 408, listing all the transactions included in the transaction group. Administrator 402 may manually remove transactions from the transaction group. Administrator 402 may manually add transactions to the transaction group.

For every transaction group, payment accounts control system 404 may display a transaction execution recommendation. An example of a transaction execution recommendation may be shown at transaction execution recommendation 410. Transaction execution recommendation 410 may include transaction execution instruction 412. Transaction execution instruction 412 may include a recommendation to freeze the transactions. Administrator 402 may accept or decline transaction execution instruction 412.

In response to accepting or declining transaction execution instruction 412, payment accounts control system 404 may display reversal option 414. Reversal option 414 may enable administrator 402 to reverse the acceptance or declination of transaction execution instruction 412. Upon selection of the freeze transactions option, reversal option 414 may enable administrator 402 to revert the freeze option or retain the freeze option.

Payment accounts control system may include AI model override button 416. AI model override button 416 may disable the AI model from automatically executing transaction execution recommendations. Disabling the AI model from automatically executing transaction execution recommendations enables administrator 402 to accept or decline transaction execution recommendations.

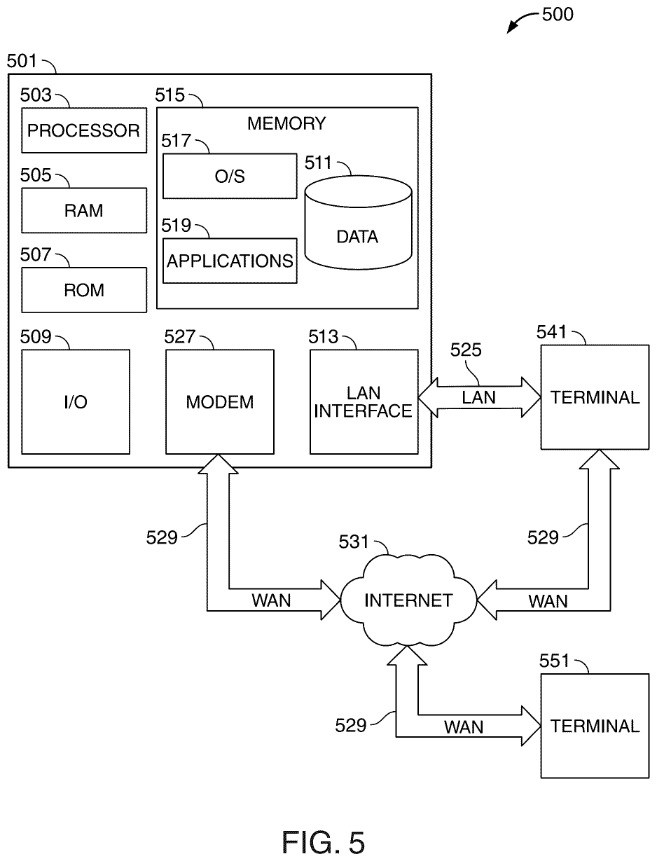

FIG. 5 shows an illustrative block diagram of system 500 that includes computer 501. Computer 501 may alternatively be referred to herein as an “engine,” “server,” or a “computing device.” Computer 501 may be a workstation, desktop, laptop, tablet, smartphone and/or any other suitable computing device. Elements of system 500, including computer 501, may be used to implement various aspects of the systems and methods disclosed herein. Each of the systems, methods and algorithms illustrated above/below may include some or all of the elements and apparatus of system 500.

Computer 501 may include processor 503 for controlling the operation of the device and its associated components, and may include RAM 505, ROM 507, input/output (“I/O”) 509, and a non-transitory or non-volatile memory 515. Machine-readable memory may be configured to store information in machine-readable data structures. Processor 503 may also execute software running on the computer. Other components commonly used for computers, such as EEPROM or flash memory or any other suitable components, may also be part of computer 501.

Memory 515 may include any suitable permanent storage technology, such as a hard drive. Memory 515 may store software including the operating system 517 and application program(s) 519 together with any data 511 needed for the operation of the system 500. Memory 515 may also store videos, text and/or audio assistance files. The data stored in memory 515 may also be stored in cache memory and/or any other suitable memory.

I/O module 509 may include connectivity to a microphone, keyboard, touch screen, mouse and/or stylus through which input may be provided into computer 501. The input may include input relating to cursor movement. The input/output module may also include one or more speakers for providing audio output and a video display device for providing textual, audio, audiovisual and/or graphical output. The input and output may be related to computer application functionality.

System 500 may be connected to other systems via a local area network (“LAN”) interface 513. System 500 may operate in a networked environment supporting connections to one or more remote computers, such as terminals 541 and 551. Terminals 541 and 551 may be personal computers or servers that include many or all of the elements described above relative to system 500. The network connections depicted in FIG. 5 include LAN 525 and a wide area network (“WAN”) 529 but may also include other networks. When used in a LAN networking environment, computer 501 may connect to LAN 525 through LAN interface 513 or an adapter. When used in a WAN networking environment, computer 501 may include modem 527 or other means for establishing communications over WAN 529, such as Internet 531.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 519, which may be used by computer 501, may include computer executable instructions for invoking functionality related to communication, such as e-mail, Short Message Service (“SMS”), and voice input and speech recognition applications. Application program(s) 519 (which may be alternatively referred to herein as “plugins,” “applications,” or “apps”) may include computer executable instructions for invoking functionality related to performing various tasks. Application program(s) 519 may utilize one or more algorithms that process received executable instructions, perform power management routines or other suitable tasks.

The invention may be described in the context of computer-executable instructions, such as application(s) 519, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 501 and/or terminals 541 and 551 may also include various other components, such as a battery, speaker and/or antennas (not shown). Components of computer system 501 may be linked by a system bus, wirelessly or by other suitable interconnections. Components of computer system 501 may be present on one or more circuit boards. In some embodiments, the components may be integrated into a single chip. The chip may be silicon-based.

Terminal 541 and/or terminal 551 may be portable devices such as a laptop, cell phone, tablet, smartphone or any other computing system for receiving, storing, transmitting and/or displaying relevant information. Terminal 541 and/or terminal 551 may be one or more user devices. Terminals 541 and 551 may be identical to system 500 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

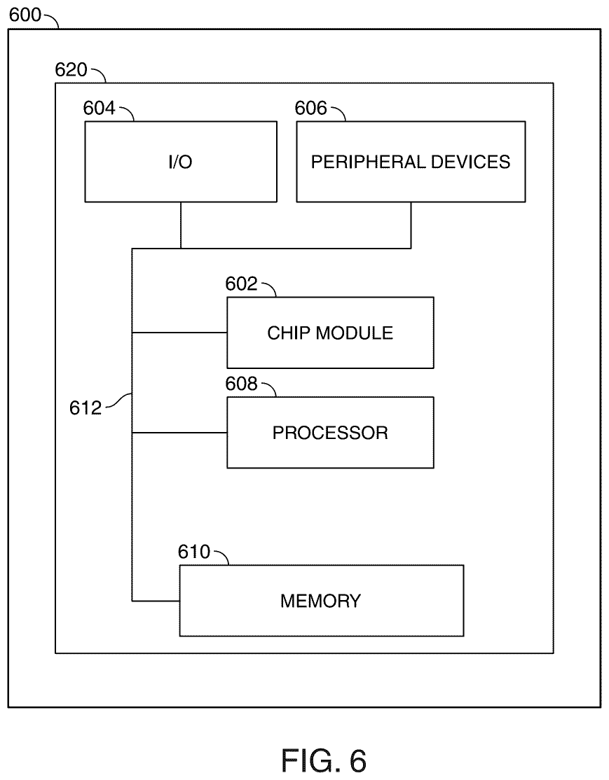

FIG. 6 shows illustrative apparatus 600 that may be configured in accordance with the principles of the disclosure. Apparatus 600 may be a computing device. Apparatus 600 may include one or more features of the apparatus shown in FIG. 5. Apparatus 600 may include chip module 602, which may include one or more integrated circuits, and which may include logic configured to perform any suitable logical operations.

Apparatus 600 may include one or more of the following components: I/O circuitry 604, which may include a transmitter device and a receiver device and may interface with fiber optic cable, coaxial cable, telephone lines, wireless devices, PHY layer hardware, a keypad/display control device or any other suitable media or devices; peripheral devices 606, which may include counter timers, real-time timers, power-on reset generators or any other suitable peripheral devices; logical processing device 608, which may compute data structural information and structural parameters of the data; and machine-readable memory 610.

Machine-readable memory 610 may be configured to store in machine-readable data structures: machine executable instructions, (which may be alternatively referred to herein as “computer instructions” or “computer code”), applications such as applications 519, signals, and/or any other suitable information or data structures.

Components 602, 604, 606, 608, and 610 may be coupled together by a system bus or other interconnections 612 and may be present on one or more circuit boards such as circuit board 620. In some embodiments, the components may be integrated into a single chip. The chip may be silicon-based.

Thus, methods and apparatus for a CONFIGURABLE TRANSACTION FREEZE are provided. Persons skilled in the art will appreciate that the present disclosure can be practiced by other than the described embodiments, which are presented for purposes of illustration rather than of limitation and that the present disclosure is limited only by the claims that follow.

What is claimed is:

1. A method for using artificial intelligence (“AI”) to generate and execute configurable guardrails to select and freeze attempted transactions, the method comprising:
receiving, from a user associated with an entity, a plurality of parameters, each parameter being associated with a threshold that is used to determine whether to enable an attempted transaction to be executed;
using an AI model:
dynamically updating the plurality of parameters, the updating being configured via the AI model receiving:
real-time transactional data via a live data feed, the real-time transactional data including publicly available transactional data and internal entity transactional data; and
historical transactional data;
monitoring a plurality of payment accounts which are operated by the entity, each payment account being configured to execute transactions;
in parallel with the monitoring, classifying into a plurality of transaction groups transactions that are attempted by the plurality of payment accounts, each transaction group including transactions that each include at least one shared transaction characteristic; and
using the updated plurality of parameters, determining transaction execution instructions for each transaction group;
transmitting a plurality of transaction recommendations to the user, each transaction recommendation including the determined transaction execution instructions for each transaction group;
in parallel with the transmitting, using the AI model, comparing the transaction recommendations for each transaction group to historical transaction recommendations that were made for each transaction group, the comparing being used to further train the AI model;
based on the comparing, updating the transaction execution instructions via the AI model;
using a feedback loop, generating guardrails to enable automatic execution of transaction recommendations without input from the user, the generating the guardrails including:
assigning an accuracy score to each iteration of the feedback loop, each iteration of the feedback loop including a generated transaction recommendation and a predicted transaction execution decision based on the historical transactional data;
setting an accuracy score bracket reflecting a range of accuracy scores that indicate that the transaction recommendation is substantially the same as the predicted transaction execution decision; and
for each iteration of the feedback loop:
determining whether the accuracy score assigned to the iteration is included in the accuracy score bracket;
in response to determining that the accuracy score is included in the accuracy score bracket, automatically executing the transaction recommendation associated with the iteration; and
in response to determining that the accuracy score is not included in the accuracy score bracket, transmitting the transaction recommendation to the user;
wherein:
the user is provided with selectable options whether to execute a received transaction recommendation;
selection, by the user, to execute the received transaction recommendation results in an execution of transaction execution instructions included in the transaction recommendation; and
in the event that the feedback loop determines that the received transaction recommendation has an accuracy score included in the accuracy score bracket, the received transaction recommendation is not transmitted the user and, instead, is executed automatically without input from the user.

2. The method of claim 1 wherein a transaction recommendation includes a transaction execution instruction to freeze transactions included in a transaction group.

3. The method of claim 1 wherein a transaction recommendation includes a transaction execution instruction to execute transactions included in a transaction group.

4. The method of claim 1 wherein a transaction recommendation includes a transaction execution instruction delay execution of transactions included in the transaction group.

5. The method of claim 1 wherein the at least one shared transaction characteristic includes a common geolocation.

6. The method of claim 1 wherein the at least one shared transaction characteristic includes a common payment method.

7. The method of claim 1 wherein the at least one shared transaction characteristic includes a common transaction recipient.

8. The method of claim 1 further including:
ranking each transaction group based on a transaction importance level; and
for transaction groups ranked above a threshold transaction importance level, initiating an AI model override, the AI model override disabling automatic execution of a transaction recommendation.

9. The method of claim 1 further including after executing a transaction recommendation, providing to the user an option whether to reverse the executed transaction recommendation or to enforce the executed transaction recommendation.

10. The method of claim 9 wherein when the transaction recommendation includes a transaction execution instruction to freeze transactions included in a transaction group, reversing the executed transaction recommendation includes unfreezing the transactions included in the transaction group.

11. An apparatus using artificial intelligence (“AI”) to generate and execute configurable guardrails to select and freeze attempted transactions, the apparatus comprising:
a user account associated with an entity, the user account configured to control a plurality of payment accounts which are operated by the entity, each payment account being configured to execute transactions; and
an AI model, the AI model including a processor and at least one machine learning engine, the AI model configured to receive from a user associated with the user account, a plurality of parameters, each parameter being associated with a threshold that is used to determine whether to enable an attempted transaction to be executed, the AI model configured to:
receive:
real-time transactional data via a live data feed, the real-time transactional data including publicly available transactional data and internal entity transactional data; and
historical transactional data;
dynamically update the plurality of parameters using the real-time transactional data and the historical transaction data;
monitor attempted transactions being executed from the plurality of payment accounts;
concurrently classify the attempted transactions into a plurality of transaction groups, each transaction group including transactions that each include at least one shared transaction characteristic; and
based on the updated plurality of parameters, determine transaction execution instructions for each transaction group;
transmit a plurality of transaction recommendations to the user, each transaction recommendation including the determined transaction execution instructions for each transaction group;
in parallel with the transmission, compare the transaction recommendations for each transaction group to historical transaction recommendations that were made for each transaction group, the comparison being used to further train the AI model:
based on the comparison, update the transaction execution instructions;
using a feedback loop, generate guardrails to enable automatic execution of transaction recommendations without input from the user;
assign an accuracy score to each iteration of the feedback loop, each iteration of the feedback loop including a generated transaction recommendation and a predicted transaction execution decision based on the historical transactional data;
set an accuracy score bracket reflecting a range of accuracy scores that indicate that the transaction recommendation is substantially the same as the predicted transaction execution decision; and
for each iteration of the feedback loop:
determine whether the accuracy score assigned to the iteration is included in the accuracy score bracket;
in response to the determination that the accuracy score is included in the accuracy score bracket, automatically execute the transaction recommendation associated with the iteration; and
in response to the determination that the accuracy score is not included in the accuracy score bracket, transmit the transaction recommendation to the user;
wherein:
the user account includes a graphical user interface;
the user is provided, via the graphical user interface, with selectable options whether to execute a received transaction recommendation;
selection, by the user, to execute the received transaction recommendation results in an execution of transaction execution instruction included in the transaction recommendation; and
in the event that the feedback loop determines that the received transaction recommendation has an accuracy score included in the accuracy score bracket, the received transaction recommendation is not transmitted the user and, instead, is executed automatically without input from the user.

12. The apparatus of claim 11 wherein a transaction recommendation includes a transaction execution instruction to freeze transactions included in a transaction group.

13. The apparatus of claim 11 wherein a transaction recommendation includes a transaction execution instruction to execute transactions included in a transaction group.

14. The apparatus of claim 11 wherein a transaction recommendation includes a transaction execution instruction delay execution of transactions included in the transaction group.

15. The apparatus of claim 11 wherein the at least one shared transaction characteristic includes a common geolocation.

16. The apparatus of claim 11 wherein the at least one shared transaction characteristic includes a common payment method.

17. The apparatus of claim 11 wherein the at least one shared transaction characteristic includes a common transaction recipient.

18. The apparatus of claim 11 wherein the AI model is further configured to:
rank each transaction group based on a transaction importance level; and
for transaction groups ranked above a threshold level of importance, initiate an AI model override, the AI model override configured to disable automatic execution of a transaction recommendation.

19. The apparatus of claim 11 the AI model further configured to, after executing a transaction recommendation, provide to the user an option, via the graphical user interface, whether to reverse the executed transaction recommendation or to enforce the executed transaction recommendation.

20. The apparatus of claim 19 wherein when the transaction recommendation includes a transaction execution instruction to freeze transactions included in a transaction group, reversing the executed transaction recommendation includes unfreezing the transactions included in the transaction group.
